(19) United States
(12) Patent Application Publication
(10) Pub. No.: US 2004/0034801 A1
(43) Pub. Date: Feb. 19, 2004

(54) Method for creating and using computer passwords

(76) Inventor: Denny Jaeger, Oakland, CA (US)

Correspondence Address: Harris Zimmerman, Law Offices of Harris Zimmerman, Suite 710, 1330 Broadway, Oakland, CA, 94612, US

(21) Appl. No.: 10/635,883

(22) Filed: Aug. 5, 2003

Related U.S. Application Data
(63) Continuation-in-part of application No. 09/880,397, filed on Jun. 12, 2001.
Application No. 09/880,397 is a continuation-in-part of application No. 09/785,049, filed on Feb. 15, 2001.

(51) Int. Cl. H04L 9/00

(52) U.S. Cl. 713/202

(57) ABSTRACT

A method for creating and using computer passwords includes the steps of displaying graphic objects on the display, selecting a plurality of the graphic objects and designating them as a password, applying the password to lock and password-protect a further graphic object, whereby the further graphic object cannot be accessed unless the password is first used to unlock the protected object. The combinatorial possibilities of the password includes the categories of the plurality of objects, the colors of the plurality of objects, and the spatial arrangement of the plurality of objects.

### CROSS-REFERENCE TO RELATED APPLICATIONS

This application is a continuation-in-part of U.S. patent application Ser. No. 09/880,397, filed Jun. 12, 2001, which is a continuation-in-part of U.S. patent application Ser. No. 09/785,049, filed Feb. 15, 2001, for which priority is claimed. The entireties of the prior applications are incorporated herein by reference.

### FEDERALLY SPONSORED RESEARCH

Not applicable.

### SEQUENCE LISTING, ETC ON CD

Not applicable.

### BACKGROUND OF THE INVENTION

1. Field of the Invention

The invention relates to a software system for creating and utilizing passwords.

2. Description of Related Art

A password is generally recognized as a secret word or phrase that one must use to gain entry to a place, or a sequence of characters that one must key into a computer to gain access to part of a computer system. Passwords generally comprise a combination of numerical, alphabetic, or symbolic characters, and are often chosen by users to be some sequence that is easily remembered by the user (forgotten passwords are a very common user problem). As such, users are tempted to use character sequences that are already memorized, such as social security number, telephone number, license plate number, birthday digits, and the like. They are also likely to save their passwords in some file in the computer itself, to avoid being locked out of access by a moment's forgetfulness. Both traits are exploitable by a determined computer hacker, who may input every combination of characters pertinent to a user's circumstances, or by searching for the password file in the user's computer.

The common shortcomings to passwords described above, as well as other drawbacks, exemplify ways in which the theoretical odds of obtaining a password are reduced from the usual astronomical number to a much lower, and more practicable opportunity to gain unauthorized access to a computer, computer file, communications channel, or the like. Thus password protection in a computer system may not provide the security that is required or desired by a computer user or owner.

### BRIEF SUMMARY OF THE INVENTION

A significant feature of this invention is the utilization of hand drawn computer entries of on-screen objects to create passwords. Factors in the creation of hand drawn passwords include the color of the drawn entries, the shape or configuration of the hand drawn entries, the order in which the entries are drawn, the layer of the hand drawn entries and the location of the hand drawn entries with respect to each other and to other onscreen objects.

Other significant features of this invention include:

A method for applying passwords created with hand drawn entries to password protect or “lock” objects, including: VDACCs, assigned-to objects (see the Arrow patent, the section entitled: Place Inside), Info Canvas entries (see patent XXX), folders, files, logs, email entries, etc.

The use of images (pictures) combined with hand drawn inputs to create passwords.

The use of text and punctuation to create passwords.

The present invention generally makes use of a system for facilitating the entry of inputs to a graphic user interface system that receives hand drawn entries. Such inputs may be made using a pen, stylus, mouse, trackball, voice or any equivalent device or method known in the prior art. A significant aspect of the interface is that it enables a user to designate a finite number of drawn inputs as a password that can be used to lock (password protect) any graphical item displayed on a computer screen or its equivalent. This system has particular value for enabling password protection of graphical items that a user can operate in various ways. Examples of such operations would be left-clicking on a switch to cause a certain type of action to be performed. Another example would be clicking on an object that has had various items placed inside of it (for example that have been placed there by drawing an arrow that has a “Place Inside” arrow logic assigned to it)—see U.S. patent application Ser. No. 09/880,397, filed Jun. 12, 2001.

The desired result of the utilization of such a password is to allow a user to cause actions controlled by a graphical object, while preventing any unauthorized user from causing the actions controlled by the graphical object or its equivalent to be carried out. As an example, in the case of a switch, password protecting a switch will prevent any unauthorized user from clicking on and activating the switch. In the case of an assigned-to object, like a star or ellipse, having a password protect such an object will prevent any unauthorized user from clicking on the object and seeing the items that have been placed inside of it from appearing onscreen.

In this application, the following terms may be found, and are defined thusly:

Log: A log is a file that contains at least the following:

A snapshot of all graphics and their locations onscreen at the time the log was saved.

All the setups (the relationships of each graphic object to every other graphic object) as they existed onscreen at the time that the log was saved.

A living record of all the functions and operations that were active at the time the log was saved. Please refer to the co-pending application VDACCs and Info canvases XXXX.

Glue: There are two types of glue, temporary and permanent. Glue is used to group two or more graphical items together. These items can be text, recognized geometric shapes, free drawn lines, images (photos), video, etc. Temporary glue is achieved by selecting two or more items, as with a lasso or by drawing an ellipse or rectangle. In either case, the lasso and hand drawn graphical object must either intersect or encircle all items that are being selected. Once the selection process is made, these items are temporarily glued. (need flow chart for temporary glue). To create permanent glue, a menu selection is activated causing the selected items to be permanently grouped (glued) together.

Determinant: A factor defining the number of elements that are used to calculate the total possible combinations for a password.

VDACC: This is an acronym that stands for “Virtual Design and Control Canvas.” This is an object managing system that is disclosed in the co-pending application “VDACCs and Info canvases XXX.

IVDACC: An IVDACC is also explained in the co-pending application “VDACCs and Info canvases XXX.

Info Canvas: An Info Canvas is explained in the co-pending application “VDACCs and Info canvases XXX.

Line: A line is a graphical input to a computer, generally caused by hand drawing with a mouse or touch pen on a computer monitor or touch screen or both.

Recognized object: A recognized object is any of a group of geometric objects that the software system of this invention recognizes. This is explained in U.S. patent application Ser. No. 09/785,049, filed Feb. 15, 2001.

Color palette: Any structure that can be used to select a variety of colors for creating hand drawn inputs.

Mouse cursor: equals the pen tip for activating actions.

The system of this invention can be used to create passwords with at least the following inputs:

A. Hand drawn entries.

B. Photographs.

C. Graphical devices, like faders, knobs, switches and joysticks.

D. Typed text, punctuation and the like.

Below are further descriptions of the inputs listed above.

A. Hand Drawn Computer Entries.

Hand drawn computer entries can be inputted using a color wheel to select from millions of different colors. For example, a 24-bit color wheel, common in the art, will produce approximately 16 million different colors. The password system of this invention keeps track of each hand drawn entry, including its color, location, layer, the order that it was inputted, etc.

In one embodiment of the invention, the user creates a hand drawn entry by first selecting a color from a 24, 32, 64 bit color wheel or its equivalent. Then the user enables a drawing function. This can be done by activating a switch, making a selection in a menu, speaking a word or phrase, etc. Then the user clicks with his mouse or its equivalent and draws a line onscreen.

As the user draws each new line, the software system enters the line's color, location, and order, etc., into memory or its equivalent. For instance, as an alternate to storage only in memory, hand drawn inputs, which equal lines on a display could be saved to a storage device, like a hard drive or writable CD, as a file that can added to and updated each time a new line is inputted by the user. Such lines can be inputted by any means common in the art, plus vocal inputs. When the user has finished inputting the desired number of lines for their password, these lines can be selected and converted to become a password. There are various methods to accomplish this task.

Various methods of selecting hand drawn entries:

1. Using a lasso tool to intersect or encircle each line that is to become part of a password.

2. Creating an additional hand drawn input in the shape of an ellipse or rectangle or any other suitable shape such that the additional drawn input either intersects or encircles each line or its equivalent that is desired to be part of a password.

3. Using a spoken command to select graphical inputs, e.g., lines, desired to be part of a password.

Various methods of converting hand drawn entries to a password:

1. Right-click on any hand drawn input, e.g., a line, in a selected group of hand drawn inputs to get a menu, window or Info Canvas (see pending patent app XXX) for that line. In the Info Canvas for this line, activate the entry “Make Password.”

2. Use a verbal command “Make Password” or its equivalent after selecting the hand drawn inputs, e.g., lines that are desired to be part of a password.

3. Draw an additional input that is a graphical object that has had the action “Make Password” assigned to it.

The following is one method of assigning the action “Make Password” to a switch: A user would type the words “Make Password” onscreen. Then they would draw an arrow that represents the arrow logic “assign an action to”. They would draw this arrow such that the shaft of the arrow intersects the words “Make Password” and that the tip of the arrow intersects the switch. When the drawing of this arrow between the text “Make Password” and a switch is recognized as a valid context for this type of arrow, the arrowhead for this arrow turns white. When this white arrowhead is left-clicked on the assignment of the action “Make Password” to the switch is complete. The switch may be labeled “Make Password” to make plain its function.

Details of using an arrow logic are found in U.S. patent application Ser. No. 09/880,397, filed Jun. 12, 2001. This does not disclose the use of “assign an action to” logic, but the operation of arrows and arrow logics are disclosed. Please note that the drawing of any arrow between any one or more items does not necessarily require that the arrow intersect these items. The arrow could have its origin start within a certain distance from an item, like a millimeter, and have its tip end within a certain distance of the target item and the assignment can still take place. This distance, which we refer to as the “default gap” is a user defined distance. This default gap can be set up in a menu by typing a numerical parameter or by speaking a value, etc.

4. Activate a switch that equals the action “Make Password.”

In another embodiment of the invention, a user can input a recognized object (see U.S. patent application Ser. No. 09/785,049, filed Feb. 15, 2001). These recognized objects could be stars, rectangles, ellipses, circles, squares, triangles, etc. These recognized objects can be inputted in any color from any available color palette. If, for example, a color is selected from a 24 bit color palette, 16 million different colors are be available for each inputted (e.g., drawn) recognized object.

Any number of recognized objects in any number of colors can be input and then converted to a password. To convert recognized objects to a password, a user would do the following: (1) select the recognized objects that are desired to be converted to a password, and then (2) activate the action “Make Password” or its equivalent.

In another embodiment of this invention, hand drawn inputs that are lines and hand drawn inputs that are recognized objects can be combined to create a single password. A user accomplishes this task by drawing one or more lines and then drawing one or more recognized objects, in any order or combination, and then selecting these graphical objects and converting them to a password by one of the methods described above.

B. Images, E.g., Photographs, Screen Captures, Etc.

The software system of this invention permits any image, e.g., photograph, chart, screen capture, etc., to be brought to a computer screen by any known method and to be converted to a password or part of a password. As part of this invention, one or more colors can be automatically assigned to an image when it is brought onscreen. The bringing of an image onscreen can be done by any of the methods common in the art, like importing or recalling using various menus, or by using a Specifier, etc.

In this invention, multiple different color palettes can be used to assign multiple colors to drawn inputs. These palettes can have any number of available colors. By the way of example, there may be two color palettes and one of them has 34 colors and the other has 16 million colors.

In one embodiment of this software system, any color palette that is visible onscreen will have its current selected color automatically assigned to any image that is brought onscreen. With the two color palettes, as just described above, visible onscreen, two colors will be assigned to any image brought onscreen. If this image is converted to a password, the two currently selected colors in the two color palettes will determine the total number of combinations for the image password.

If a user wished to have different colors assigned to each image brought onscreen, then the current selected color in each color palette onscreen could be changed to a new color. The when a new image was brought onscreen, the colors assigned to it would be different.

In another embodiment of the software system, using the same color palette example as above, both selected colors in both visible color palettes, plus the characters that make up the name of an image brought to the screen, can be used to create a password. If an image is converted to a password, the two colors currently selected in the visible color palettes, plus the characters in the name of the image will determine the total number of possible combinations of the image password. Determining that the characters that make up the name of an image is to become an additional designation for a password, can be selected in a menu, Info Canvas or its equivalent or it can simply be a default operation set in the software and not by the user.

In another embodiment of the software system, the two colors, and/or the characters in the image's name and the image file type can be used to determine the total combinations for a password created from that image. Examples of image file types are: .png, .jpeg, .gif, .tiff, .bmp, etc. Determining that the image file type, that is part of the name of an image, is to become an additional designation for a password, is selected in a menu, Info Canvas or its equivalent or it can simply be a default operation set in the software and not by the user.

In still another embodiment of the software system, two colors, and/or the characters in the image's name, and/or the image file type, plus added hand drawn entries (e.g., lines) that are draw on or under the image can be used to create an even more complex password with even more combinations. Determining that the image file type, that is part of the name of an image, is to become an additional designation for a password, is selected in a menu, Info Canvas or its equivalent. Additionally this feature can simply be a default operation that is set in the software and not by the user.

Note that adding hand drawn entries to an image can further insure that an image that other users have, can be customized to become a unique password for every user of that image.

There are various ways to add one or more hand drawn lines or graphics to an image. One way is to use an eyedropper tool for two purposes: (1) to make the currently selected color in a color palette perfectly match a section of color in an image, and (2) to create one or more inputs (e.g., lines) on or under the image.

(1) Making the currently selected color in a color palette perfectly match a selection of color in an image. To do this, the eyedropper is activated for a color palette and then it is used to click on a section of color on an image. This action changes the currently selected color in this palette to the color in the image.

(2) Using the eyedropper to draw one or more inputs (e.g., lines) on an image. With the software system of this invention, the eyedropper can be used to create hand drawn inputs. To create such an input on an image a user would click and drag the eyedropper on the image and this would result in the drawing of a line that matches the currently selected color in the inkwell to which the eye dropper belongs.

It would be best to draw very small lines, or dots, or small recognized objects (e.g., a star, check mark, circle, etc.) directly on top of the section of the image where the eye dropper had been clicked to change the color of the color palette to match the color in this section of the image. Since the color of the hand drawn input perfectly matches the color in the section of the image being drawn on with the eyedropper, the hand drawn input (line) being added to the image will not be detectable by the human eye. After adding one or more hand drawn inputs to the image in the manner just described, the image will still appear to be completely unaltered. No added lines or graphical objects will be visible.

This method can be repeated to add multiple hand drawn inputs onto a single image. Each time a new input is added to the image, the color of the area of the image where the hand drawn input is to be added, is touched by the eyedropper so that the color palette changes to this color. Then the input, which is drawn directly on top of this section of the image, will not be detectable.

Once a sufficient number of hand drawn inputs have been added onto the image, both the image and the added inputs are selected, as with a lasso. Then “Make Password” is selected, spoken, written, or activated by some equivalent method to convert the image, with its added hand drawn inputs, to a password.

In another embodiment of this invention, hand drawn inputs (e.g., lines) can be draw under an image and then glued (grouped) to the image. Since the hand drawn inputs are glued under the image, they cannot be seen, so they do not have to match the colors of any sections of the image where they are drawn. These inputs can be any size and can be any color. It would be preferable to have these inputs not extend beyond the perimeter of the image, because in this way they will remain undetectable to the human eye. This way they will remain concealed by the image although they are glued (grouped) to the image and will therefore move with the image when and if the image is dragged onscreen to a new location.

One method to glue these added hand drawn inputs under an image is accomplished by doing the following: (1) drag the image on top of added drawn inputs so that the inputs are obscured by the image, (2) select the image and the added lines under it, as with a lasso or hand drawn input like an ellipse, and (3) activate the function “Make Password.” Activating the function “Make Password” will automatically glue (group) the hand drawn inputs to the image.

Note that if a lasso is used to select an image and hand drawn inputs added under it, the lasso should be drawn such that the entire perimeter of the image is inside the circumference of the lasso. This will ensure that both the image and the hand drawn inputs under it have been selected. Then the image and all of the hand drawn inputs under it will be glued together by activating “Make Password”.

The activation of the function “Make Password” does at least two things: (1) it automatically glues all elements together that have been selected by some suitable method, as with a lasso or verbal command or with an additional hand drawn input, like an ellipse or rectangle, and (2) it converts both the image and the selected hand drawn inputs under it to a password.

The use of the elements listed above combine to create a very low probability that an unauthorized user could recreate a password. Let's consider using two colors, one from a 24 color palette and one from a 16 million color palette. The number of combinations due to assigning these two colors to a photo are:

34×2²⁴

The number of possible characters that are available for the name of an image vary from operating system to operating system. Let's assume 85 characters (26 upper case letters, 26 lower case letters, and 23 punctuations, e.g., quote, exclamation point, period, etc.). As an example, assume there are 13 characters in a image's name. This would produce the following combinations:

85¹³=1.2×10²³ combinations

However, this figure assumes that all combination of allowed characters are equally likely. This is clearly not the case. For instance, letters are more likely to be used than %, \hat{ }, /, }, etc. Also, different letters occur with different frequency in English. And certain letters imply a next letter, e.g., the letter “q” is usually always followed by the letter “u.” To be conservative one might say that the number of combinations is likely to be between 8.2×10¹⁶ and 1.2×10²³. Given these numbers, the total possible combinations for a photo with two colors assigned to it (as described above) and a 13 character name would be between 34×2²⁴×20¹³=4.7×10²⁵ and 34×2²⁴×85¹³=6.9×10³³ The number of different possible combinations for a hand drawn entry like a line are 2²⁴ for each line that is added to an image, the number of combinations is multiplied by 2²⁴. Consider the possibilities below.

| # of lines | Low estimate | High estimate |
|---|---|---|
| added to photo | combinations | combinations |
| 1 | 7.8 × 10³² | 1.2 × 10⁴¹ |
| 5 | 6.2 × 10⁶¹ | 9.2 × 10⁶⁹ |
| 10 | 1.4 × 10¹⁰⁵ | 2.0 × 10¹¹³ |

Further development of the theory of the password system. Most users are familiar with typing a password. It may be the last six digits of your Social Security number, the nickname for you dog, your birth date, etc. These types of passwords are simple and do not provide strong protection, because they do not create a large number of possible combinations. For instance, there are 26 letters in the alphabet and if you use upper and lower case letters for your password, the total number of combinations is 52⁶=2×10¹⁰.

If, however, a user draws 50 hand drawn lines (as in a sketch), where each line could be any color, as selected from a 24 bit color palette (16 million available colors), the potential combinations for a password created from these lines would be 10³⁶¹ combinations. A password created from 200 such lines would equal 10¹⁴⁴⁴ combinations. This is calculated as follows. A 24 bit color wheel has 16 million available colors. This is 2²⁴ different colors. This is usually called 16 million, but it is actually 16,777,216.

Two free drawn inputs (lines) generates (2²⁴)². Three free drawn inputs generate (2²⁴)³. So for five free drawn inputs the number of combinations is (2²⁴)⁵=1.3×10³⁶. You can cross check this by saying that 2²⁴ is approximately 16 millions=1.68×10⁷, then (1.68×10⁷)⁵=(1.68)⁵×10³⁵=1.3×10³⁶. The more combinations you have, the harder it is for someone to figure out what your password is. For instance 128 bit encryption equals 3.0×10³⁸ combinations. Using 5 free drawn inputs with colors selected from a 24 bit color wheel equals 1.3×10³⁶ combinations. Using 50 lines equals over 10 combinations. The point here is that is it very easy to draw lines to create a sketch onscreen. It doesn't take any appreciable time to draw a sketch that uses 50 lines or more. Almost any simple drawing or sketch can contain this many lines. For instance, each time the mouse is clicked or a pen is touched to a touch screen to draw a new hand drawn input, this constitutes adding a new line to a sketch. This is a natural and intuitive thing to do and if each added input (e.g., line) is drawn using a different color from a 24 bit color wheel, the potential possible combinations for the sketch becomes trillions of combinations. This is where the protection comes from. For a hacker to determine which are the exact colors of the lines used in a password created from a sketch that has trillions of possible combinations is not an easy task.

The image discussed above has a password with number of combinations between 4.7×10²⁵ and 6.9×10³³. If the order of 50 hand drawn inputs were added to this image, as a determining factor to that password, the total possible combinations for this password would be increased from between 10²⁵ and 10³³ to between 10³⁸⁶ and 10³⁹⁴.

It should be noted that hand drawn inputs could be replaced with mechanized or computer controlled or generated drawn inputs. An example of this would be using a mechanical drawing arm to create drawn inputs. Another example would be using a random computer-generated series of inputs that utilize drawn characters, lines, recognized objects and the like. These could be computer selected and automatically converted to become a password.

Graphical devices, like faders, knobs and switches and joysticks. Graphical devices can be used as passwords. Graphical devices are assigned a color when they are created. The color that is assigned to them is the currently selected color in any one or more color palettes that are currently visible onscreen when the device is created. For information about creating graphical switches, please refer to U.S. patent application Ser. No. 10/103,680, filed Mar. 22, 2002. For information about creating graphical faders and knobs, please refer to U.S. patent application Ser. No. 09/785,049, filed Feb. 15, 2001.

As an example, let's say a user employs Object Points to create a switch. At the moment the switch is recognized, whatever color is selected in one or more color palettes will be assigned automatically to that switch. The same principle applies to the creation of a fader, knob, joystick, etc. In another embodiment of the invention, graphical switches can be used along with hand drawn entries, like lines and recognized objects to create more complex passwords with greater numbers of combinations than just using devices alone.

In addition, any number of devices can be used to create a password. The creation of a password using devices can be accomplished by doing the following: (1) create one or more devices as described above, (2) select these devices, as with a lasso, and (3) activate “Make Password” by clicking on this entry in an Info Canvas, or in a menu or by activating a switch with the action “Make Password” assigned to it, or by using a verbal command. When “Make Password” is selected, the individual devices are automatically glued (grouped) together and are converted to become a password.

D. Text, punctuation and the like. Letters, numbers, punctuation and the like can be inputted and converted to a password by multiple methods. Three such methods are: (1) hand drawing recognized characters, and (2) typing characters on an alphanumeric keyboard or its equivalent, and (3) verbal commands.

Hand drawing characters. Hand drawn characters, when input in conjunction with character recognition software, can be used to create letters and numbers and punctuation. These can be converted to a password by the following method: (1) select the characters desired to be converted to a password, and (2) activate “Make Password” by any of the above described methods.

Typing characters. Any kind of text character in any language can be used to create a password. Anything that can be typed can be used, e.g., Russian characters, Chinese characters, Italian letters, etc. In addition, any punctuation found on a keyboard in any font can be used to create passwords as well. This includes the forward and back slash, quotes, half quotes, a period, comma, brackets, etc. To create a password using any one or more typed characters, the following steps are carried out: (1) select a color from a color palette, (2) type one or more characters, (3) select another color and type one or more characters. Continue until the desired number of characters have been typed, and (4) select all of the characters that are desired to be converted to a password and activate “Make Password.”

Verbal commands, A verbal command may be used to create characters, such as speaking “capital H” or “lower case I”, etc. These can be converted to a password by the following method: (1) verbalize the desired characters, (2) select the characters desired to be converted to a password, and (3) activate “Make Password” by any of the above described methods.

Ordering the characters onscreen. Text characters do not have to be typed and arranged in a line as in a sentence or phrase. Each character can be its own object, typed as a separate text object. Then the characters can be placed directly on top of each other to create a stack of characters that may be only partially readable. The software system keeps track of each character that is created, what its color is, what its position is and what its order is in relation to the other characters in the vertical stack of characters. To convert a character stack to a password, select all of the characters in the stack and then activate “Make Password.”

In another embodiment of the invention, a user can opt not to select all of the characters in a group of characters, but instead leave one or more of them unselected. The selected characters can then be converted to a password, while the unselected characters will not become part of that password. However, these characters can be glued (grouped) to the password to appear as though they are part of the password. When the password is moved, these extraneous glued characters will move with it as though they are part of it. This approach acts to confuse someone who happens to view another user's text character password. By visual inspection there would be no way to know what the actual elements of the password are.

Using a password as defined by this invention to lock an item. The current use of passwords in existing software generally involves the entering of password information into a menu of some kind. Usually one enters one or two copies of the password in multiple fields in the password menu. If the multiple entries match exactly, the item is either locked or unlocked by the password. The invention does not require entering a password into a menu of any kind. Instead the following options are available:

A. Draw the password each time it is to be used. This is quite practical if a sketch is used as a password and the sketch has a small enough number of lines to be accurately reproduced each time it is drawn. An example of this would be drawing a happy face sketch that has six lines in it, where the first three lines are a first color, the fourth line is a second color, and the fifth line is a third color. By turning on only “Use graphical order” in the Info Canvas for the happy face, the following factors will affect the creation of a password from a happy face sketch or any sketch using six lines: (1) the currently selected color in an inkwell used to draw each line, (2) the order that the lines are drawn.

B. Store the password in a hidden place on a user's computer. This can be accomplished by various methods. Below is an example of one such method. Create a recognized object or a switch and assign the password to it. Let's say the password is an image with 5 lines added to it as described above. Once the image with its added 5 lines is converted to a password, it will act as a single object. Thus dragging the image will simultaneously drag the 5 lines added to it. To assign this password to, let's say a green star, would require the following: (a) Draw an arrow that has the logic “place inside” assigned to it where the shaft of the arrow intersects any part of the image, (b) Point the tip of this drawn arrow to the object to which the user wishes to assign the image to, in this case, a green star, (c) Touch tip of the arrowhead (which turns white after being drawn to the star) and the assignment is completed. At this point the password will disappear into the green star. Touch the green star and the password will reappear where it last was when it was assigned to the star. Touch the green star again and the password will again disappear into it. As a final note here, the object to which the password is assigned could be made to be invisible and then placed inside an Info Canvas or in another object. The idea here is that a user may not need to protect their password from hostile individuals on their own computer as much as they need to protect themselves from hostile individuals trying to hack into the media, documents, messages, etc., that are being password protected by this password and then sent via the Internet to third parties, who will use the same password to unlock what is sent to them.

C. Password protect the object to which the password has been assigned. Once a password is assigned to, let's say a green star as in the above example, this green star itself can be locked with another password. This secondary password should be a password that the user remembers and is not stored on the computer. However, this secondary password could also be stored in a secret place or protected by a third password and so on.

D. Using a password of the invention to lock an item, like a folder, graphic object, device, menu or Info Canvas entry, email entry, folder, file and the like. To password protect anything that can be password protected, the user would do the following:

A. Drag the password so that the tip of the mouse cursor is anywhere over the top of the item that is desired to be password protected.

B. Do a mouse up-click after positioning the tip of the mouse cursor as described in A above.

When the above procedure is properly carried out, the password will snap back to the position where it previously was, prior to being dragged it over the item being password protected.

If the password snaps back, the user knows that it has been successfully password protected. To check this, the user can click on the item. Clicking on a password protected item, will result in a pop up menu appearing telling the user that the item is password protected.

Using a password to lock an entry in an Info Canvas. Info Canvases and VDACCs are disclosed in co-pending application XXXX. Since Info Canvases are comprised of individual VDACCs, called IVDACCs, each IVDACC is a separate unit capable of having the action assigned to it, locked by a password. To lock the action of any IVDACC in an Info Canvas, a password is dragged to the overlap the IVDACC such that the tip of the mouse cursor is anywhere within the perimeter of the IVDACC. Upon the mouse upclick, the password snaps back to its original location and the IVDACC's action is password protected (locked). After being locked, if one attempts to activate this VDACC by any means, the activation of this IVDACC's action will not take place.

Using a password as defined by this invention to unlock an item. To unlock any item that has been password protected by a password of this invention, do the following:

A. Drag the password over the top of the item that is to be unlocked, such that the tip of the mouse cursor is over the top of the item.

B. Do a mouse upclick. Upon the mouse upclick, if the password that was dragged over the top of the locked item perfectly matches the password that was used to lock the item, the dragged password will snap back to where it originally was prior to being dragged. The item will then be unlocked by this password.

If the password does not perfectly match the password that was used to lock an item, the dragged password will not snap back to its original position. Instead the password will sit where it was dragged and nothing else will happen. This will indicate to a user that the wrong password was used to unlock the item. The item will then remain locked.

Passwords are not saved with a file. The passwords of this invention are not saved in a file as readable passwords. Instead they are created when the file is loaded. Because of this, hackers cannot easily hack into a file or log and see combinations of a password, and therefore use this information to crack encrypted files. The password system of this invention keeps the password as a cryptic representation stored with the file, where such cryptic representation is reconstructed as the password that the user employed to lock the file or item. Then when a user applies a password to unlock a file or item the password is rebuilt into the file so that it can be compared with the password that is being used to unlock the file. If the two passwords match, then the file is unlocked. If not the file remains locked.

The passwords of this invention can automatically invoke 128 bit or 1024 bit encryption as part of their password protection. If desired, users can select an option in a menu or Info Canvas that causes the password protecting of an item to automatically add encryption to the locking of the item. This encryption can be 128 bit or 1024 bit or any other suitable bit structure.

### BRIEF DESCRIPTION OF THE DRAWING

FIG. 1a depicts the creation of a password sketch using drawn inputs.

FIG. 2a depicts the creation of a password from the password sketch shown in FIG. 1 using a lasso rectangle.

FIG. 2b depicts the creation of a password from the password sketch shown in FIG. 1 using a lasso loop.

FIG. 3 depicts an image being brought to the screen with two color palettes visible onscreen.

FIG. 4a depicts the adding of hand drawn inputs on top of the image of FIG. 3.

FIG. 4b depicts converting hand drawn inputs added on top of an image, and converting that image and the hand drawn input into a password.

FIG. 5a depicts the adding of hand drawn inputs under an image to form a password with hidden features.

FIG. 5b depicts converting hand drawn inputs added under an image, plus that image to a password.

FIG. 6a depicts assigning the action “Make Password” to a recognized graphic object that is a blue star, where the arrow intersects both the text and the recognized object.

FIG. 6b depicts assigning the action “Make Password” to a recognized graphic object that is a blue star, where the arrow does not intersect either the text or the recognized object.

FIG. 7 depicts using the file name of an image as an added determinant of a password.

FIG. 8 depicts a collection of graphic devices that have been converted to a password.

FIG. 9 depicts the creating of a password that is comprised of graphical devices and hand drawn line inputs, each created with a different color selected in a 24 bit color palette.

FIG. 10 depicts converting text and punctuation to a password where each text character is a different color and are stacked together to form a glued composite of characters.

FIG. 11a depicts using a sketch password to lock a folder.

FIG. 11b depicts using a sketch password to lock an assigned-to object.

FIG. 11c depicts using an image password to lock an entry in an Info Canvas,

FIG. 12a depicts using a password to unlock a folder.

FIG. 12b depicts using a password to unlock an entry in an Info Canvas.

FIG. 13 is a chart depicting the functions carried out by the software system in making a password.

FIG. 14 is a flow chart depicting the steps in forming a password.

FIG. 15 is a flow chart depicting how color is assigned from a 34 color palette.

FIG. 16 is a flow chart depicting how color is assigned to a picture when it is displayed.

FIG. 17 is a flow chart depicting how color is assigned to a freeline object when it is drawn.

FIG. 18 is a flowchart depicting how passwords are recreated whenever a log is loaded in the software system.

FIG. 19 is a flow chart depicting how passwords are processed for protecting an object.

FIG. 20 is a flow chart depicting how passwords are processed to protect a log.

### DETAILED DESCRIPTION OF THE INVENTION

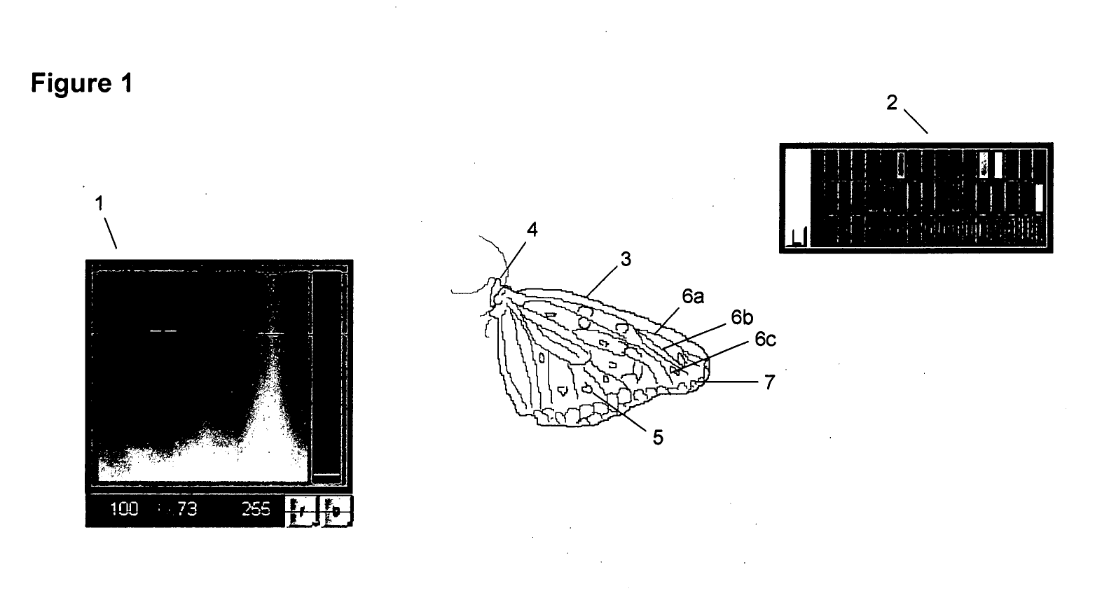

The present invention generally comprises a method for creating passwords in a computer operating environment. With regard to FIG. 1, one example of the method involves a sketch of a butterfly. Onscreen Inkwell 1 and the 24-bit Inkwell 2 were used to access colors for the lines in the sketch. As shown in FIG. 1, line 3 on the butterfly sketch is drawn in the color blue which equals the RGB color, R:100 G:73 B:255 (note these values shown in the RGB inkwell), which was selected in the 24-bit Inkwell 1. Then the color red is selected in the Onscreen Inkwell 2. This color is drawn as line 4 and 5. Then another color of blue is selected from the 24-bit inkwell and line 6a, 6b and 6c are drawn. Then another color is selected from the 24-bit inkwell and line 7 is drawn.

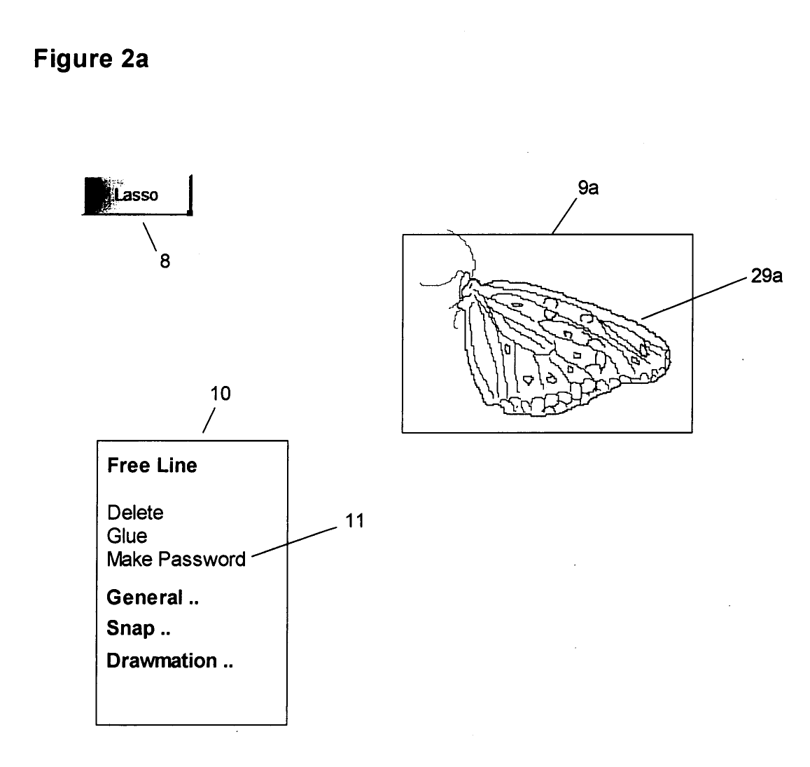

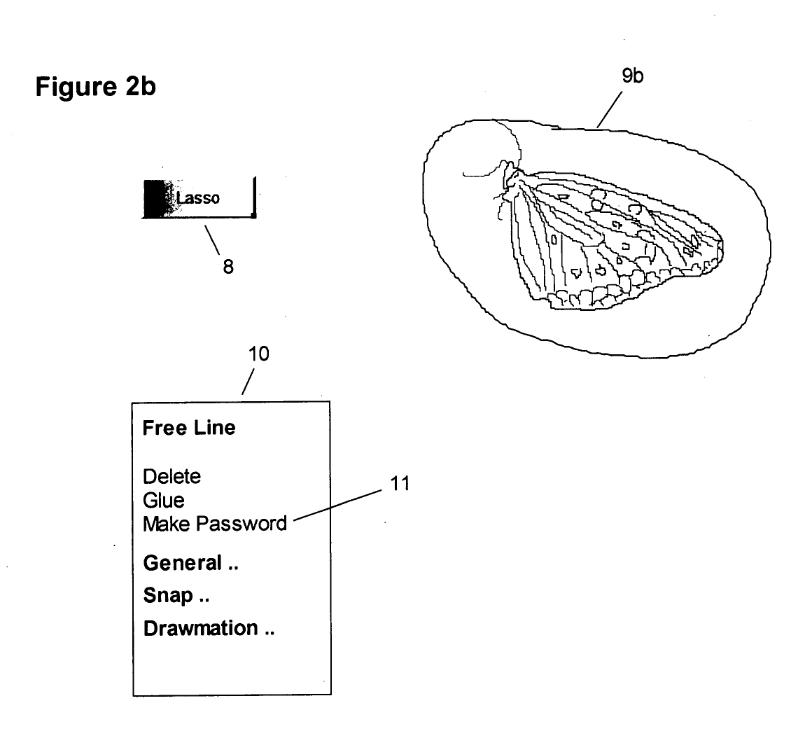

As shown in FIG. 2, the switch 8 activates the lasso function that is used to draw a rectangular shaped lasso 9a, which intersects and/or encircles the object 29a butterfly sketch. The lasso is drawn around the sketch 29a that will subsequently be designated as a password. The lasso function has been activated and has been used to intersect and/or encircle the sketch 29. Then a user can access an Info Canvas 10 for sketch 29a by right clicking on any line in sketch 29. Once the Info Canvas for sketch 29a appears the entry 11 “Make Password” can be activated by clicking on it. Once entry 11 has been activated, the sketch 29a is converted to a password. The conversion process of this sketch 29a to a password automatically glues together every individual graphical element in the sketch. FIG. 2b contains the same elements and involves the same method described in FIG. 2a, except the lasso switch is activated to enable a hand drawn closed loop lasso 9b to intersect and/or encircle sketch 29b.

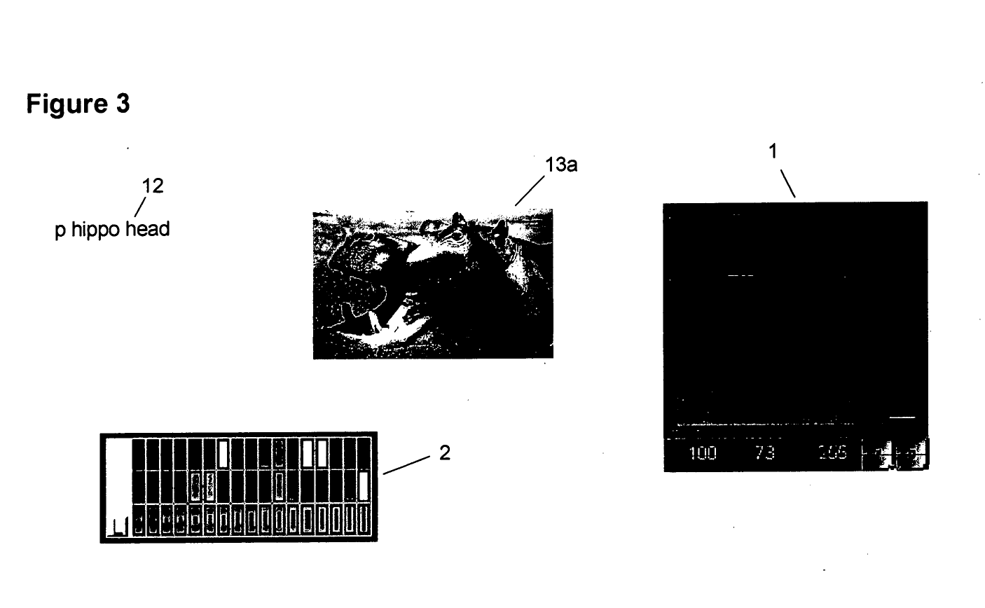

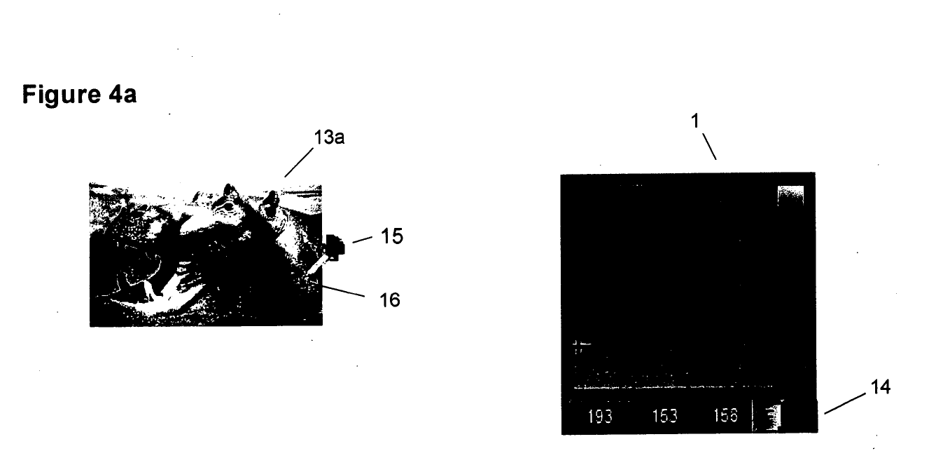

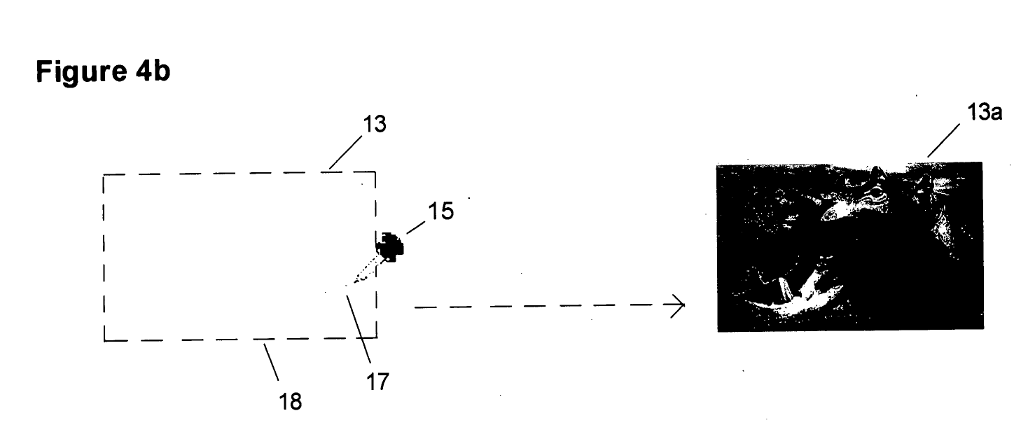

With regard to FIG. 3, another procedure for making a computer password involves using an image as a password. A text switch is activated and text 12 is written, which is a specifier (p) followed by <enter> or the like to recall an image file 13a. The currently selected colors in two visible inkwells 1 and 2 are automatically assigned to image 13a. As shown in FIG. 4, switch 14 on the 24-bit inkwell has been turned on to activate the eyedropper. Then the eyedropper 15 is used to accomplish two tasks:

(a) It is floated over the surface of the image 13a by the user and left-clicked over a section of the image. After clicking on the image, the 24-bit inkwell 1 will automatically change to the color of the section of the image that was just clicked on by the eyedropper.

(b) It is used to create one or more hand drawn inputs. To accomplish this, the user performs a left click on their mouse (or its equivalent) and then drags the eyedropper over the image in area 16. This results in the drawing of a line whose color equals the currently selected color in the 24-bit inkwell. This color now perfectly matches the color of area 16 so the hand drawn input if kept within this area is invisible to the human eye.

The eyedropper is dragged to create a small line on image 13a. Because the color of the line perfectly matches the color of the image, image 13a is pulled away to the right to reveal the line that was drawn on it with the eyedropper (FIG. 4b). The position of the image as it existed when the line was drawn on it is represented by the dotted line 18.

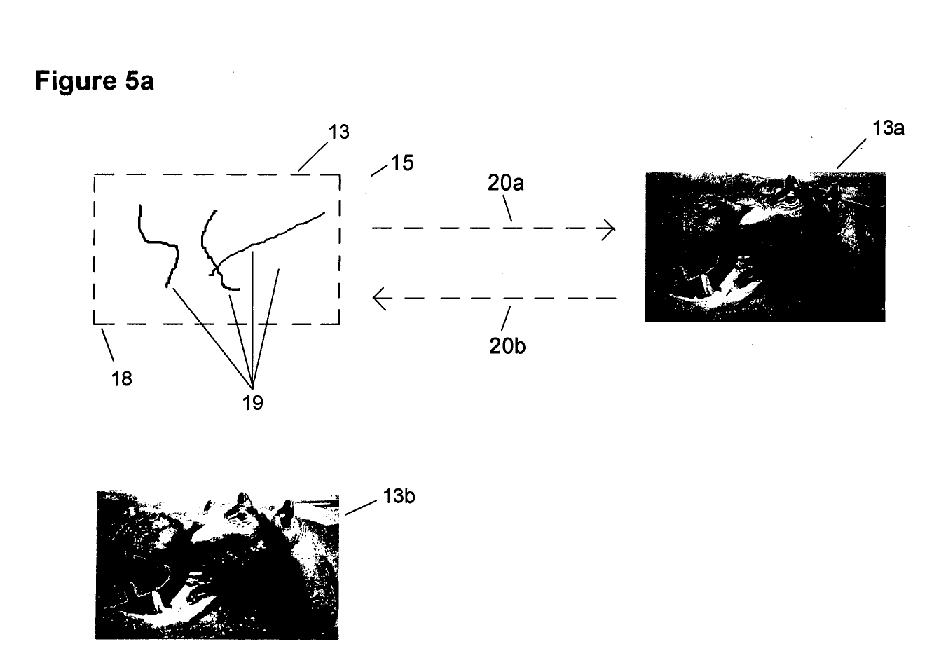

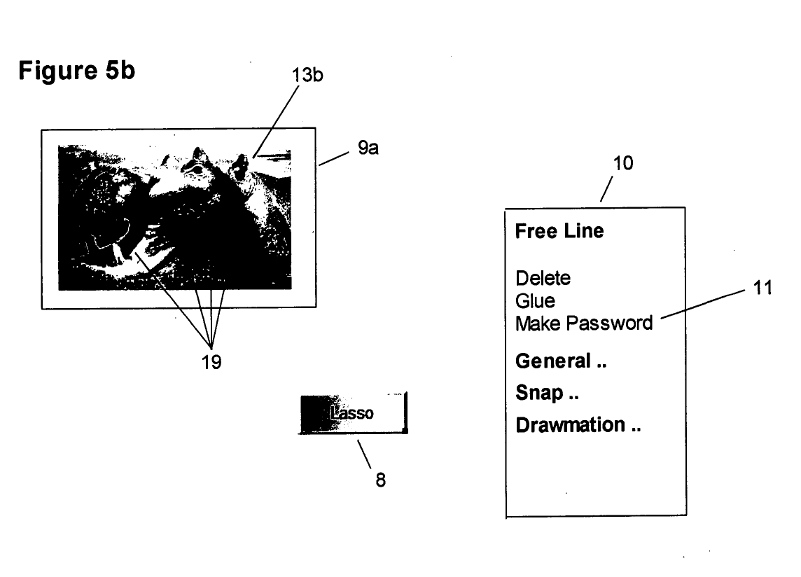

FIG. 5a shows four inputs 19 drawn on top of the image 13a. The image 13a is then moved to the side, shown by the dashed arrow 20a. When image 13a is dragged even one pixel, it becomes the top layer. The four lines 19, which were above the image 13a, are now a layer under it. The user may or may not choose to draw the four inputs 19 with the eyedropper. In any event, it is not necessary that the inputs drawn match the color of any particular section of the image 13a. Therefore the lines 19 are freely drawn as any size and shape and color. The only restriction is that the lines do not extend beyond the outer perimeter of the image 13a. The image 13a is then dragged back over the top of the inputs 19 as shown by the dashed arrow 20b. When the image is directly over the inputs 19 these inputs are no longer visible, as shown by image 13b.

Then the image 13b and the drawn lines 19 are encircled with lasso 9a activated by the lasso function key 8, followed by the entry “Make Password” being activated in Info Canvas 10, thus completing the process of creating a password from the combination of image 13b and the lines 19.

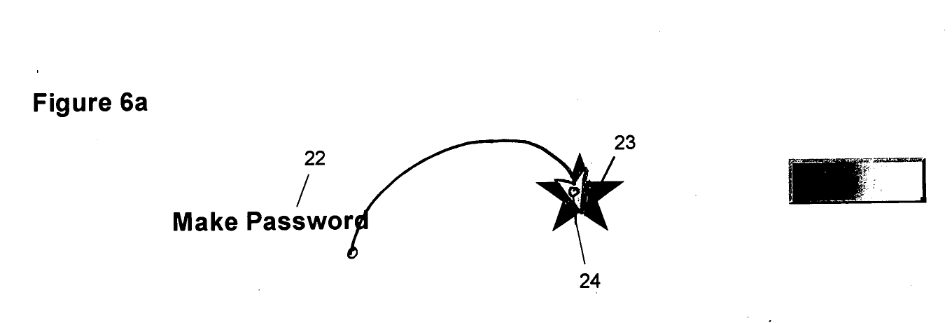

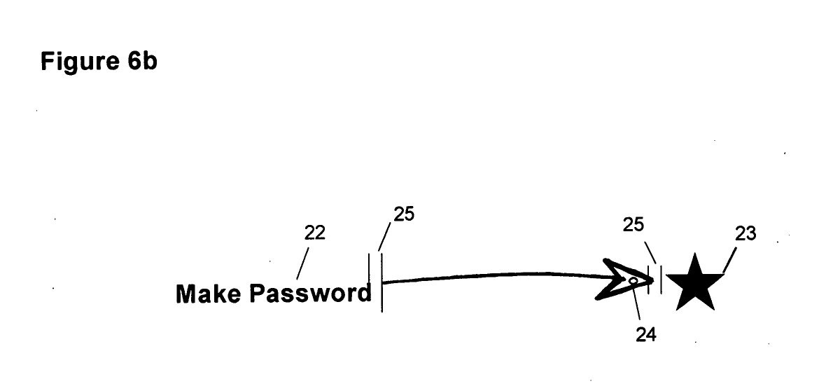

With reference to FIG. 6a, the text 22 “Make Password” is assigned to a graphical object 23, a blue star, by drawing an arrow that embodies the logic “assign an action to”, from the text 22 to the graphical object 23. The origin of the arrow intersects the text 22 and the tip of the arrow intersects the object 23. Upon the mouse upclick, the arrowhead of this drawn arrow turns white to indicate that a context has been recognized. In this case, the context is a piece of text that commands an action and a graphical object to which this action is to be assigned. When this white arrowhead is touched (clicked on), the assignment of the action “Make Password” is successfully completed. Thereafter, clicking on the “assigned-to” object 23 will cause the action assigned to it to take place.

FIG. 6b shows the same action as FIG. 6a except that in this case the origin and tip of the arrow are within a gap default 25, so that the steps proceed as described with reference to FIG. 6a. Such gap default is user definable and can be changed by entering a parameter into a menu, Info Canvas, or their equivalent.

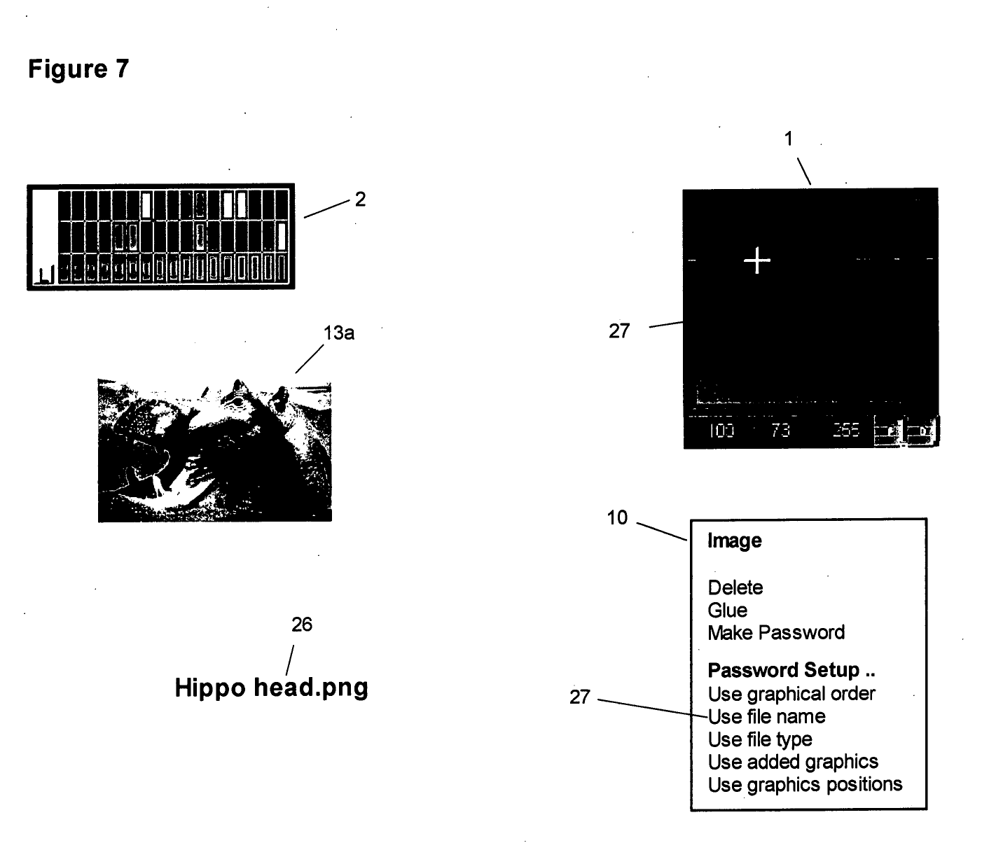

FIG. 7 shows inkwells 1 and 2, as before, plus the file name 26 of an image 13a, being used as part of a password created from this image. Then an Info Canvas 10 that is used to activate the entry “Make Password” is accessed by right-clicking on image 13a. In the Info canvas the entry 27 “Use file name” is first activated to cause the file name of the image to be added as a password determinant. Other possibilities in this Info Canvas are “Use File type” and “Use added graphics.” If these entries are activated then the file type and any added lines or recognized objects will also be used as determinants for the password created from the image.

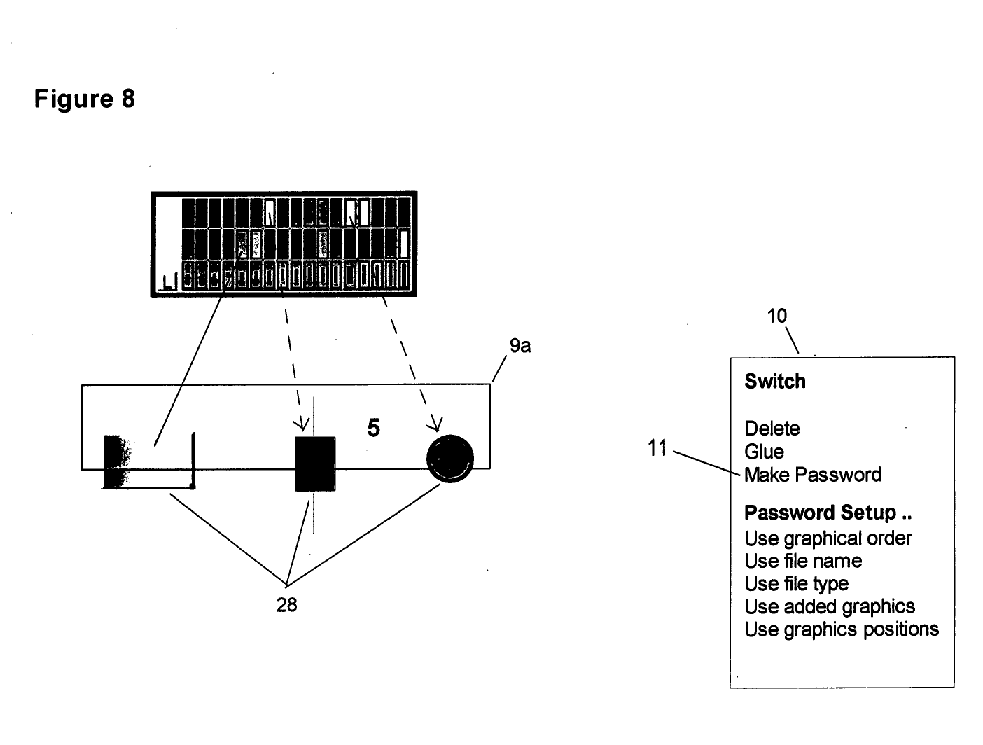

FIG. 8 illustrates the creation of a password using three graphical devices 28 where each device has a different color assigned to it. The lasso is activated and a lasso rectangle 9a is drawn, such that it intersects each of the three graphical devices 28 for the purpose of selecting them. With this selection made any one of the devices is right-clicked on to bring the Info Canvas 10 for that device to the screen. When the entry “Make Password” is clicked on in Info Canvas 10, the three selected graphical objects are converted to a password.

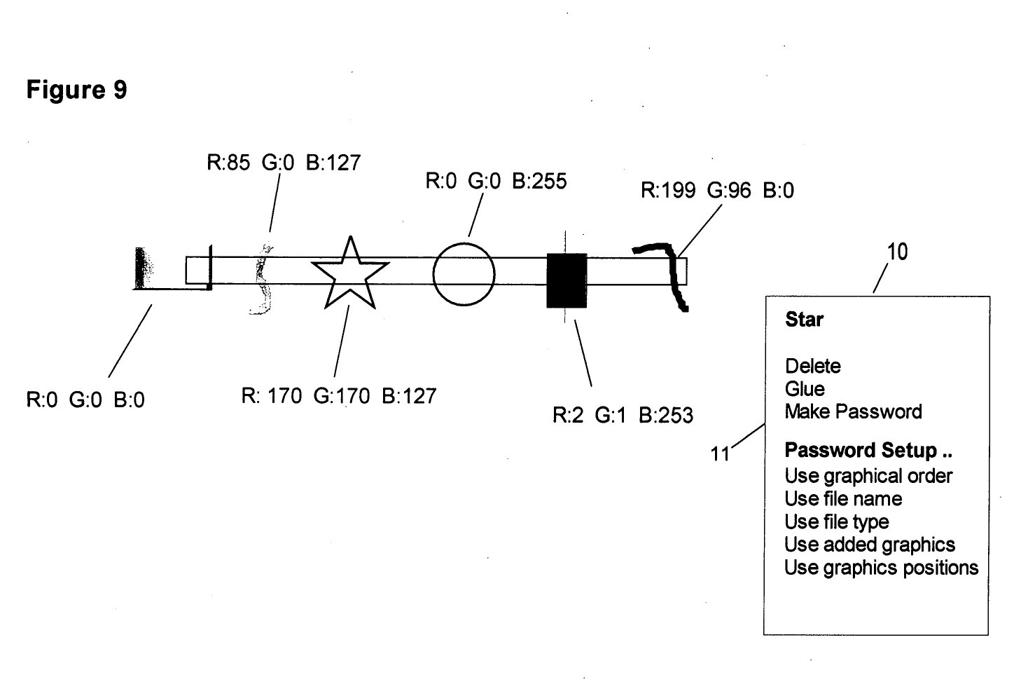

FIG. 9 illustrates the creation of a password using a set of different objects, including a graphical switch, two hand drawn lines, recognized star and circle objects, and a graphical fader device. Each item is further differentiated by being assigned a specific color, defined in terms of its red, green and blue components, from the Onscreen Inkwell 1. The lasso function is then activated and a rectangular lasso is drawn to intersect all of these items, thus selecting them. Then one of the selected items is right-clicked on to get the Info Canvas 10 for that item to appear on screen. Then the entry “Make Password” 11 is clicked on Info Canvas 10. This converts this group of devices and graphical objects to a password.

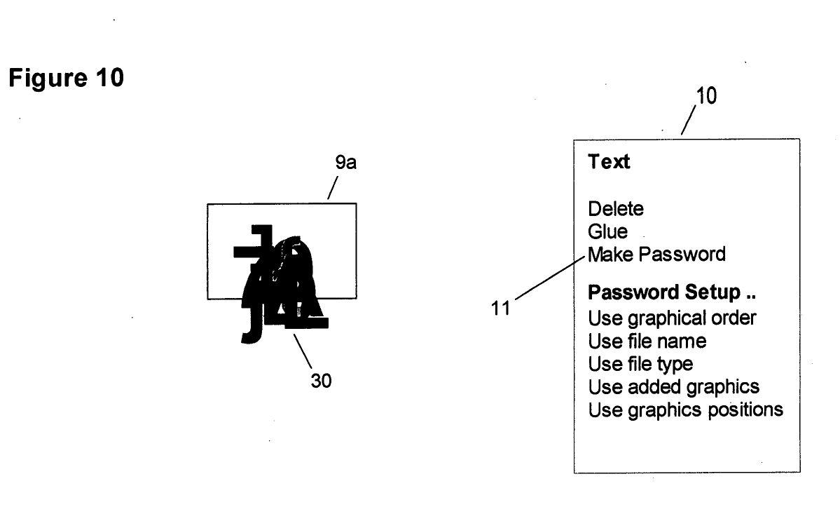

With regard to FIG. 10, eight text characters 30, each of a different color, can be superimposed one upon another (by dragging together or the like) to create a password. This is achieved through using the lasso function 9a to group the superimposed characters together. Then one of these characters is right-clicked on to make its Info Canvas 10 appear on screen. In this Info Canvas the entry “Make Password” 11 is activated by clicking on it.

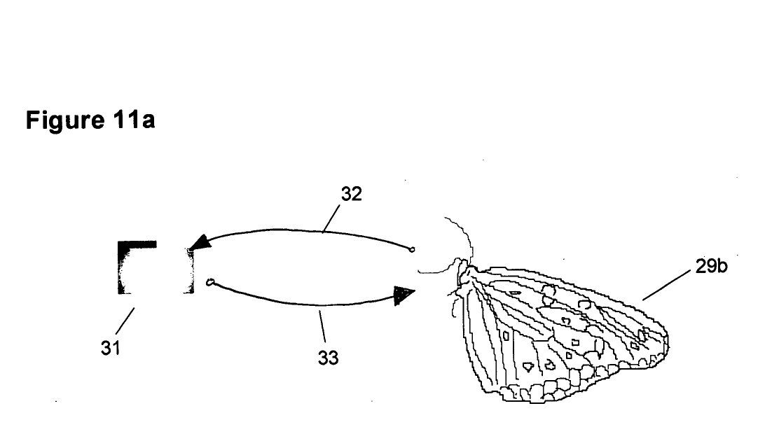

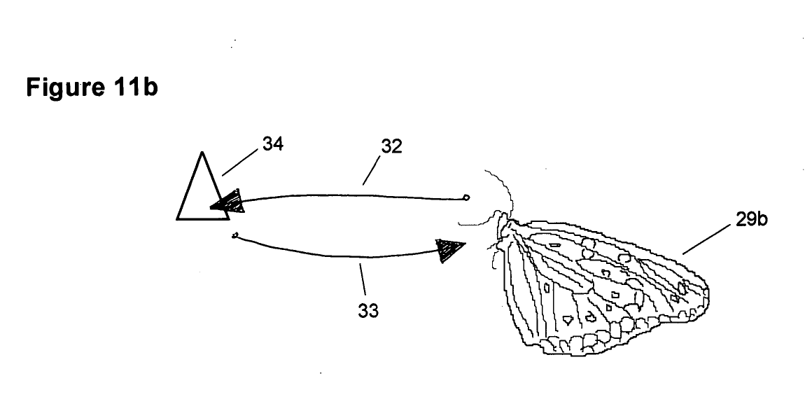

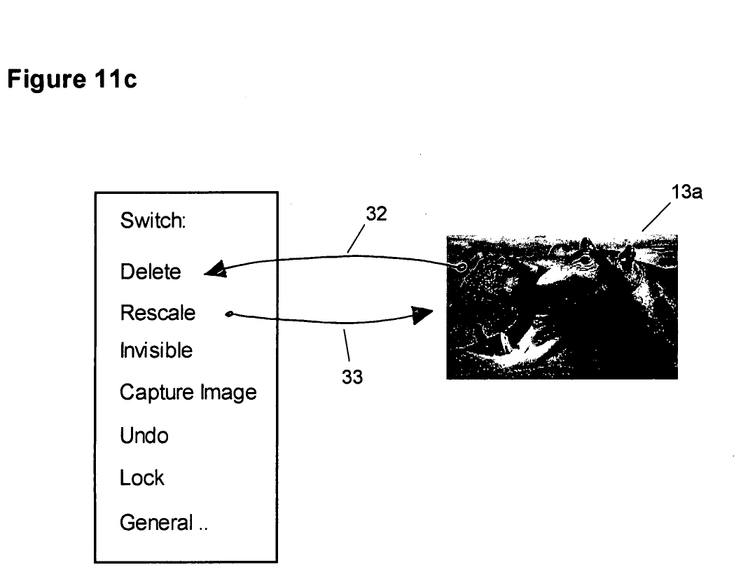

FIG. 11a illustrates how a sketch 29b, which has been converted to a password, can be used to lock (password protect) a folder 31. This action is achieved by dragging the password sketch 29b along path 32 so that the tip of the mouse cursor is over the folder 31 and is within the perimeter of the folder. Upon the mouse up-click the password sketch 29b snaps back along path 33 to the position where it was before it was dragged. This action applies the password 29b to the folder and requires that access to the folder cannot be given unless the password is first provided.

FIG. 11b illustrates how a sketch 29b, which has been converted to a password, can be used to lock (password protect) a black triangle 34. This is achieved by dragging the password sketch 29b along path 32 so that the tip of the mouse cursor is over the black triangle and is within the perimeter of the triangle. Upon the mouse up-click the password sketch 29b snaps back along path 33 to the position where it was before it was dragged. This completes the password locking of the black triangle.

FIG. 11c illustrates how an image 13a, which has been converted to a password, can be used to lock (password protect) a delete function in an Info Canvas. This is achieved by dragging the password image 13a along path 32 so that the tip of the mouse cursor is over the entry and is within the perimeter of the Delete portion of the Info Canvas. Upon the mouse up-click the password image 13a snaps back along path 33 to the position where it was before it was dragged. This completes the password locking of the delete function within the specific Info Canvas.

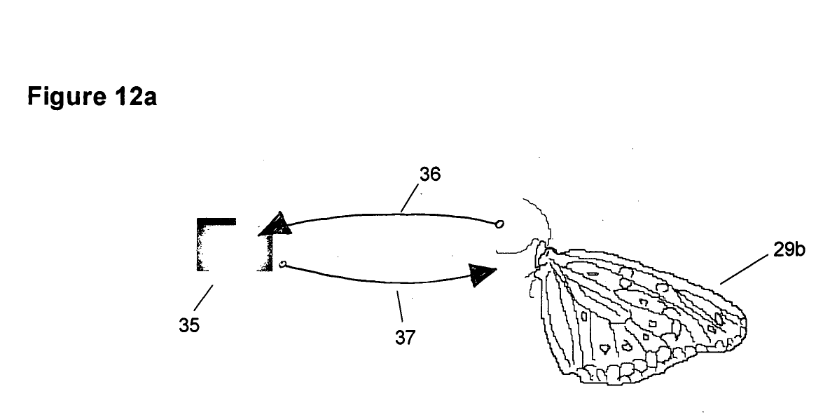

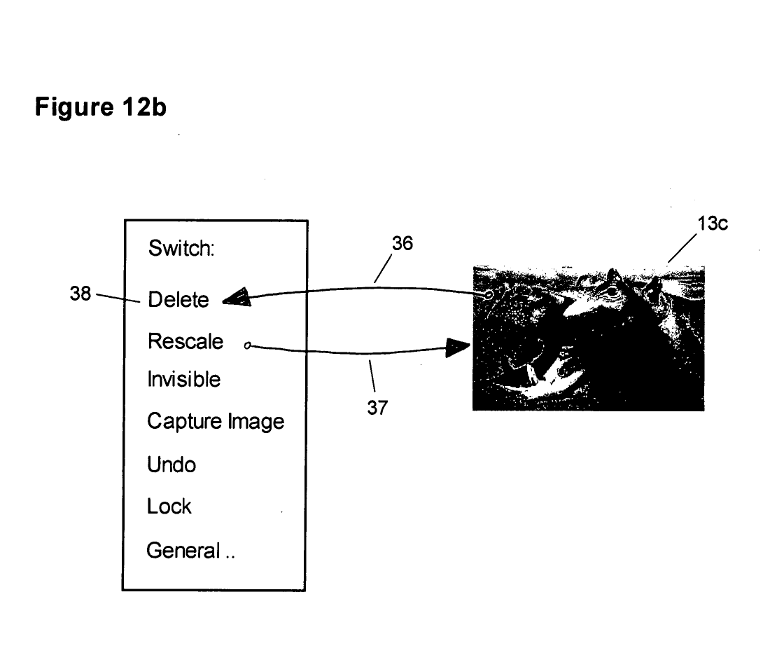

FIG. 12a illustrates how a sketch 29b, which has been converted to a password, can be used to unlock a password protected folder 35. This is achieved by dragging (shown by arrow 36) the password sketch 29b so that the tip of the mouse cursor is over the folder 35 and is within it's perimeter. Upon unlocking the folder with the password, upon the mouse up-click, the password sketch 29b snaps back (shown by arrow 37) to the position where it was before it was dragged. This completes the password unlocking of the folder. When the password sketch 29b is dragged over the folder 35, the software compares the password that was used to lock the contents of the folder to the password 29b that has been dragged to the folder. If it is an exact match, the folder is unlocked, if not the folder remains locked. The snapping back of the password 29b tells the user that the folder has been successfully unlocked. If the password is not correct it will remain positioned over the folder where it was dragged and not snap back to it's original location. This tells the user that the password is incorrect. No pop up menus or other actions are required to supply this information to the user.

FIG. 12b illustrates how an image 13c, which has been converted to a password, can be used to unlock a password protected entry in an Info Canvas. This is achieved by dragging (shown by arrow 36) the password image 13c so that the tip of the mouse cursor is over the entry and is within the perimeter of the IVDACC 38 in which the entry “Delete” resides. After opening the IVDACC with the password, upon the mouse up-click the password image 13c snaps back (as shown by arrow 37) to the position where it was before it was dragged. This completes the password unlocking of the IVDACC 38 containing the entry “Delete”.

In general terms, passwords in accordance with the present invention are made by grouping graphic objects. There are three elements that a graphic object may contribute to a password.

1. Its password key.

2. Its color

3. Its text, though this does not apply to all graphic objects.

Each type of graphic object in the system has a password key. This password key is different for each type of graphic object, but is the same for all objects of the same type. Thus every switch has the same password key. Every fader has the same password key, but the password key is different for switches and faders.

There are 2 color wheels in the system.

1. A color wheel that allows one of 34 colors to be chosen. Each of these 34 colors is a particular 24 bit color.

2. A 24 bit color wheel which allows any 24 bit color to be selected.

Free line objects have 24 bit color. Pictures use 34 colors and 24 bit color if the 24 bit color wheel is on the screen when the picture is loaded. If the 24 bit color wheel is not on the screen when the picture is loaded then just the 34 colors wheel is used. All other graphic objects just use 34 color.

For text and picture objects, the associated text is added to the password. All the text in a text object is added to the password. The filename and extension of a picture (but not the directory path) is added to the password as text.

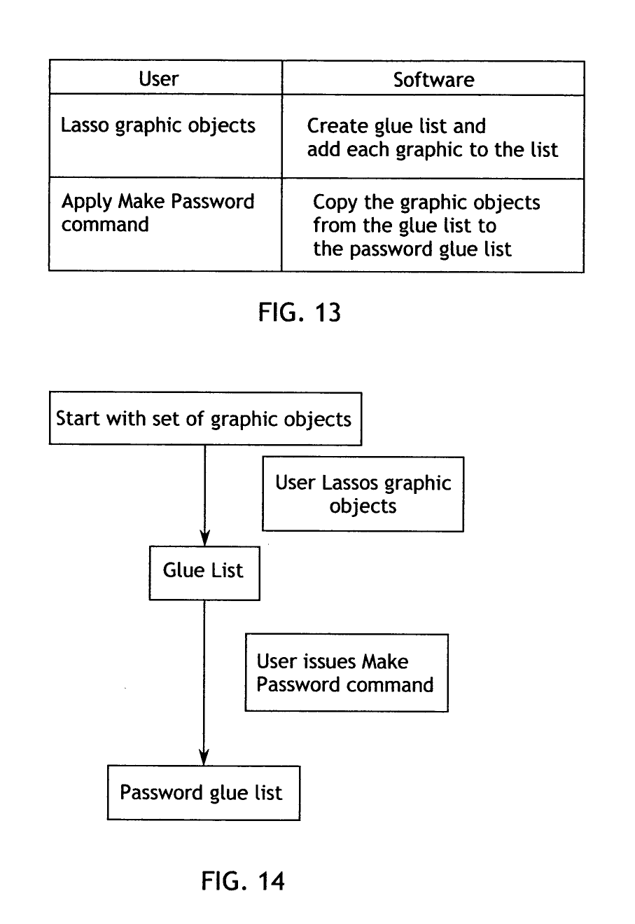

With regard to FIGS. 13 and 14, there are two steps in creating a password:

1. Lasso a group of graphic objects and invoke the make password command.

2. Drag a password to where it is to be applied.

To the user the first step ‘makes’ the password. However, it just makes a list of objects which is flagged so the system knows that this list of objects may be encoded as a password. The second step, which to the user looks like applying an already made password, actually encodes the password immediately before applying it. Encoding involves taking the list of graphic objects and producing a number that is unique to that given sequence of graphic objects. This encoded password is in a suitable form to be used with 128 bit encryption software.

In order to avoid having passwords in logs all password protection is done using encryption.

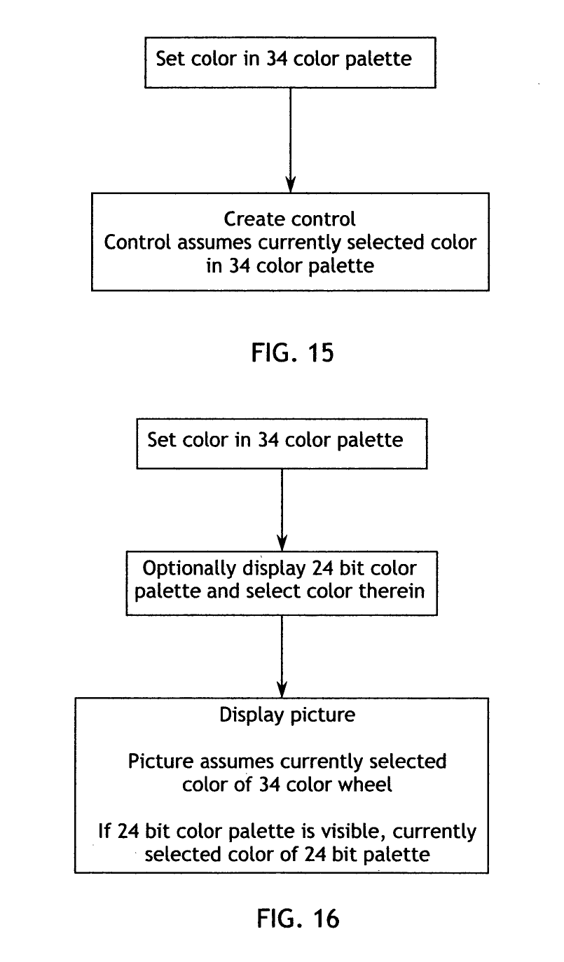

As shown in FIG. 15, color from the 34 color palette is assigned using the currently selected color when the object is created. This becomes the color for password purposes if the object is incorporated in a password. With regard to FIG. 16, 24 bit color is assigned to a picture control using the currently selected color from the 24 bit color wheel when the picture is loaded. Note that the color that is assigned does not affect the display of the picture in any way.

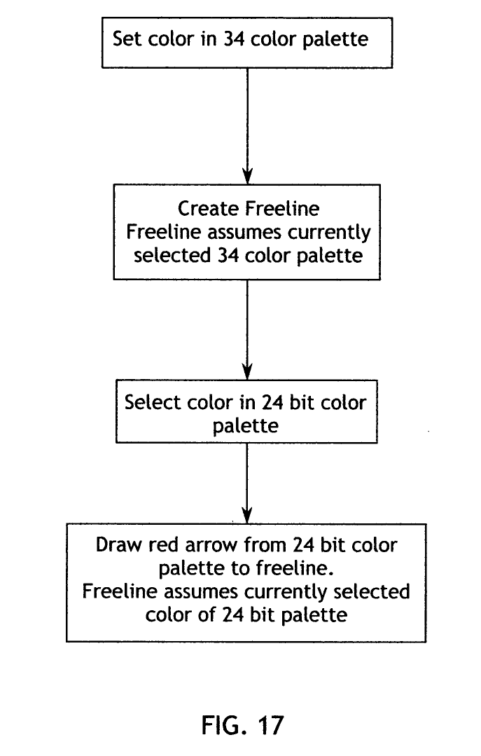

With regard to FIG. 17, a freeline object is created using the currently active 34 color palette. It may be assigned the currently selected color from the 24 bit color wheel by drawing a red arrow from 24 bit color wheel to the freeline object.

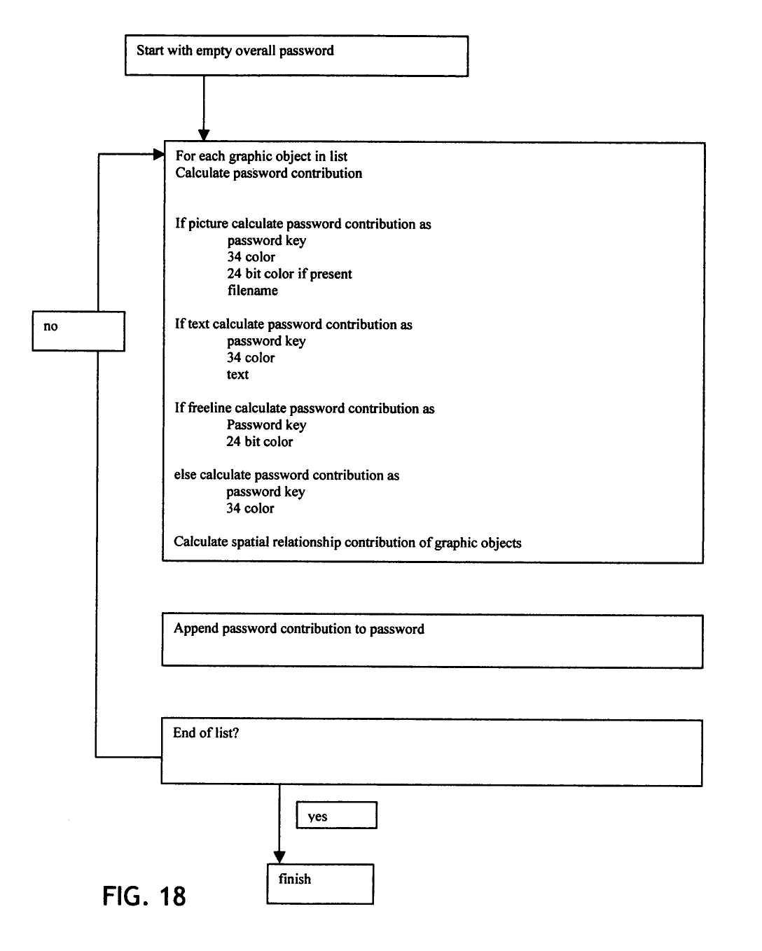

The general process for encoding a password is depicted in FIG. 18, showing the contributions of pictures, text, and freelines. This process occurs whenever a log is loaded, and is carried out for every password. Thus passwords are recreated as each log is read, and no passwords are stored in the system when not in use. Therefore passwords cannot be decoded by surreptitious means. The steps are:

1. Start with empty password. For each control in password glue list calculate the password for that control and add to overall password.

Freeline object: password is password key and 24 bit color Text object: password is password key, 34 color and text in control.

Picture: password is password key, 34 color, 24 bit color if available, and filename and extension of picture.

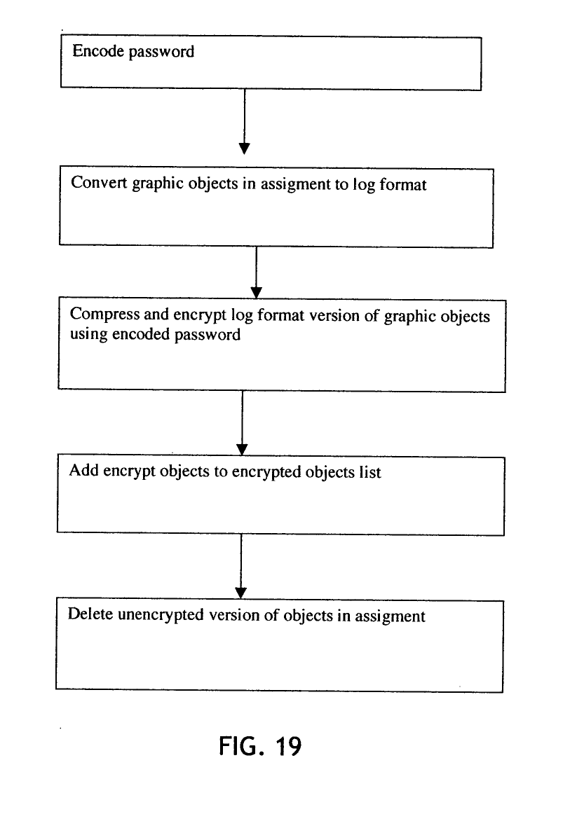

For all other graphic objects password is password key and 34 color. The steps in using a password to protect a log or when assigned to an object when the object is automatically password protected are shown in FIG. 19.

1. Encode password (see FIG. 18)

2. For each object in assignment:

a. Convert each object in assignment to log format

b. Compress and encrypt object in log format

c. Add the encrypted object to the software's list of encrypted objects

d. Delete the unencrypted copy of the object.

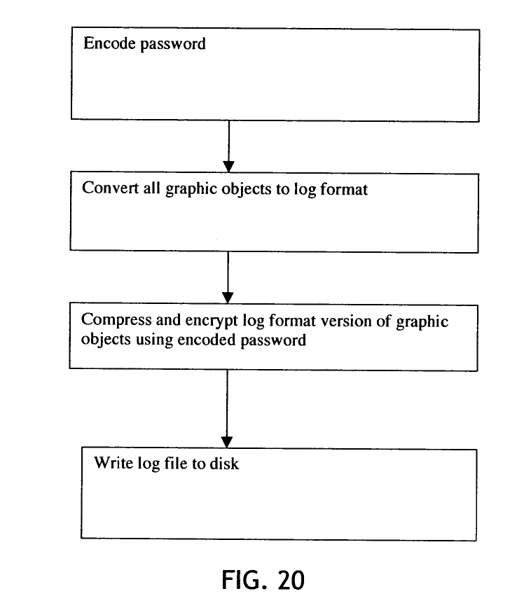

The steps for password protecting a log, shown in FIG. 20, are:

1. Encode password (see FIG. 18)

2. Convert graphic objects to log format

3. Compress and encrypt the log, using encoded password

4. Write the log to disk.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In a computer system having a display, a method for creating and using computer passwords, including the steps of:
displaying graphic objects on the display;
selecting at least one graphic object and designating it as a password;
applying said password to a further graphic object, whereby said graphic object cannot function unless said password is first applied to said further object.

2. In a computer system having a display, a method for creating and using computer passwords, including the steps of:
displaying graphic objects on the display;
selecting a plurality of said graphic objects and designating them as a password;
applying said password to lock and password-protect a further graphic object, whereby said further graphic object cannot be accessed unless said password is first used to unlock said further object.

3. The method of claim 2, wherein said plurality of objects include at least one of the following categories of graphic objects: alphanumeric characters, recognized hand drawn graphic objects, freeline hand drawn objects, and pictures.

4. The method of claim 2, wherein said plurality of objects include more than one of the following categories of graphic objects: alphanumeric characters, recognized hand drawn graphic objects, freeline hand drawn objects, and pictures.

5. The method of claim 2, wherein said plurality of objects are each displayed in a respective color.

6. The method of claim 5, further including at least two distinct color palettes, each of said plurality of objects having a respective color selected from said color palettes.

7. The method of claim 6, wherein one of said color palettes displays 34 colors.

8. The method of claim 7, wherein the other of said color palettes displays millions of colors.

9. The method of claim 4, wherein the combinatorial possibilities of said password includes the categories of said plurality of objects, the colors of said plurality of objects, and the spatial arrangement of said plurality of objects.

10. The method of claim 2, wherein said step of designating as a password includes the step of accessing the Info Canvas of one of said plurality of selected graphic objects and selecting the Make Password entry, whereby all of said plurality of selected graphic objects are incorporated into said password.

11. The method of claim 2, wherein said step of designating as a password also glues together all of said plurality of selected objects.

12. The method of claim 2, wherein said step of applying said password includes the step of dragging said password to superpose on said further graphic object.

13. The method of claim 2, wherein the step of unlocking said password-protected further object includes the steps of displaying said further object, recalling or redrawing said plurality of objects that form said password, and dragging said plurality of object to superpose on said password-protected further graphic object.
